(19) United States
(12) Patent Application Publication
(10) Pub. No.: US 2026/0091592 A1
(43) Pub. Date: Apr. 2, 2026

(54) HEATER CONTROL DEVICE, INK SUPPLY DEVICE, IMAGE FORMING SYSTEM, AND HEATER CONTROL METHOD

(71) Applicant: KYOCERA Document Solutions Inc., Osaka (JP)

(72) Inventors: Yuna Niimi, Osaka (JP); Takuma Araki, Osaka (JP)

(21) Appl. No.: 19/340,627

(22) Filed: Sep. 25, 2025

(30) Foreign Application Priority Data
Sep. 30, 2024 (JP) 2024-170773

(51) Int. Cl. B41J 2/20; B41J 2/175; B41J 29/377

(52) U.S. Cl. CPC B41J 2/20; B41J 2/175; B41J 29/377

(57) ABSTRACT

A heater control device is a heater control device which controls a heater that heats ink supplied from an ink container storing the ink to a recording head, and includes a control portion. The control portion controls, when the heater is in an operation state, the heater at a first output, and executes, when the heater is switched from a non-operation state to the operation state, output augmentation control for controlling the heater at a second output larger than the first output until a predetermined time elapses since the switch.

### INCORPORATION BY REFERENCE

This application is based upon and claims the benefit of priority from the corresponding Japanese Patent Application No. 2024-170773 filed on September 30, 2024, the entire contents of which are incorporated herein by reference.

### BACKGROUND

The present disclosure relates to a heater control device which controls a heater that heats ink, an ink supply device, an image forming system, and a heater control method.

An inkjet printer that heats ink to a predetermined temperature is known as the related art. In this inkjet printer, when a measurement value of an ink temperature is equal to or larger than a first reference temperature and smaller than a second reference temperature, a coverage rate of a page to be printed is calculated, and a power supply amount to a heater is changed in accordance with the calculated coverage rate.

As the related art, an inkjet recording apparatus is also known, which performs temperature control in which, in a temperature adjustment portion provided in the mid-course of an ink supply path, the ink temperature at a time of activation and a predetermined threshold temperature are compared, and an ink circulation amount is varied according to the comparison result to advance a recording start time.

### SUMMARY

A heater control device according to an aspect of the present disclosure is a heater control device which controls a heater that heats ink supplied from an ink container storing the ink to a recording head, and includes a control portion. The control portion controls, when the heater is in an operation state, the heater at a first output, and executes, when the heater is switched from a non-operation state to the operation state, output augmentation control for controlling the heater at a second output larger than the first output until a predetermined time elapses since the switch.

An ink supply device according to another aspect of the present disclosure includes the heater control device, the heater, the ink container, and an ink supply path for supplying the ink from the ink container to the recording head.

An image forming system according to another aspect of the present disclosure includes the ink supply device and an inkjet recording apparatus which ejects the ink supplied from the ink container from the recording head to form an image.

A heater control method according to another aspect of the present disclosure is a heater control method for controlling a heater that heats ink supplied from an ink container storing the ink to a recording head, and includes a control step. The control step includes controlling, when the heater is in an operation state, the heater at a first output, and executing, when the heater is switched from a non-operation state to the operation state, output augmentation control for controlling the heater at a second output larger than the first output until a predetermined time elapses since the switch.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic diagram showing a configuration of an image forming system according to an embodiment;

FIG. 2 is a schematic diagram showing configurations of an ink supply device and an ink supply path according to the embodiment;

FIG. 3 is a block diagram showing a configuration of a heater control device according to the embodiment;

FIG. 4 is a flowchart showing an operation example of the heater control device according to the embodiment;

FIG. 5 is a diagram showing a specific example of an operation of the heater control device according to the embodiment;

FIG. 6 is a block diagram showing a configuration of a heater control device according to a modified example of the embodiment; and

FIG. 7 is a flowchart showing an operation example of a heater control device according to another modified example of the embodiment.

### DETAILED DESCRIPTION

Hereinafter, an embodiment of the present disclosure will be described with reference to the attached drawings. It is noted that the following embodiment is an example of embodying the present disclosure and does not limit the technical scope of the present disclosure.

### 1 Overall configuration of image forming system

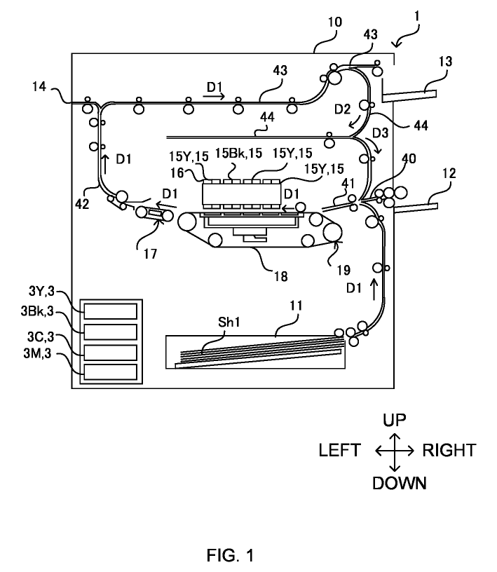

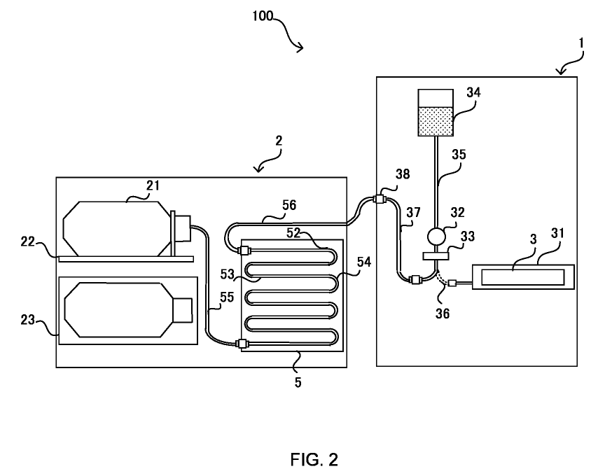

First, an image forming system 100 according to the present embodiment will be described with reference to FIG. 1 and FIG. 2. The image forming system 100 includes a printer (inkjet recording apparatus) 1 and an ink supply device 2. In descriptions below, a front side in FIG. 1 (a near side of the sheet in FIG. 1) is a front surface side (front side) of the printer 1 and the ink supply device 2, and up-down and left-right directions will be described using a direction in which the printer 1 and the ink supply device 2 are viewed from the front as a reference. It is noted that the definition of these directions is not intended to limit a manner in which the printer 1 and the ink supply device 2 are used.

In the present embodiment, for example, the printer 1 is an inkjet recording apparatus which includes a recording head 16 that ejects ink onto a surface of a sheet Sh1, and is capable of executing print processing by an inkjet method for forming an image on the sheet Sh1 using the recording head 16. In other words, the printer 1 is an inkjet recording apparatus which ejects ink supplied from an ink container 21 (to be described later) from the recording head 16 to form an image (ink image). The print processing is processing of forming an image on an image forming target. The sheet Sh1 is an example of an image forming target (recording medium) on which an image is to be formed by the printer 1, and is a sheet-like medium such as paper or a resin film.

The printer 1 only needs to have a function of forming an image by the inkjet method, and may be, for example, a multifunction peripheral having a plurality of functions such as a scanning function for reading image data from a document sheet, a facsimile function, and a copy function in addition to a printing function. Alternatively, the printer 1 may be a facsimile apparatus, a copying machine, or the like.

As shown in FIG. 1, the printer 1 includes a housing 10 that forms an outer shell of the printer 1 and houses various devices. A sheet feed cassette 11 that stores sheets Sh1 and can be freely pulled out is provided at a lower portion of the housing 10. A manual feed tray 12 on which the sheets Sh1 can be loaded manually is provided at a right side portion of the housing 10. A discharge tray 13 on which the sheets Sh1 on which images have been formed are loaded is provided above the manual feed tray 12. A discharge port 14 for conveying the sheet Sh1 to a post-processing device (not shown) adjacent to the printer 1 is provided at an upper portion of a left side portion of the housing 10. The post-processing device has, for example, a post-processing function such as a stapling function, a function as a folding machine, an inserter function, or a punching function. It is noted that the post-processing device is not essential in using the image forming system 100 according to the present embodiment.

At a center portion of the housing 10, head units 15Y, 15Bk, 15C, and 15M (hereinafter, will collectively be referred to as the "head units 15" unless stated otherwise) each including one or more recording heads 16 that eject the ink onto the sheet Sh1 are provided. The head units 15Y, 15Bk, 15C, and 15M respectively eject ink in colors of yellow, black, cyan, and magenta. Provided below the head units 15 is a conveying unit 17 that conveys the sheet Sh1 on which an image is to be formed while causing the sheet Sh1 to stick to a conveying belt 18. Provided on the left side of the conveying unit 17 is a drying unit 19 that dries the sheet Sh1 on which an image has been formed while conveying the sheet Sh1. In addition, ink containers 3Y, 3Bk, 3C, and 3M (hereinafter, will collectively be referred to as the "ink containers 3" unless stated otherwise) that respectively store the ink of the corresponding colors are housed at a lower left portion of the housing 10.

Provided on a right side of the conveying unit 17 a first conveying path 41 leading from the sheet feed cassette 11 to the conveying unit 17 and a manual feed conveying path 40 that joins the first conveying path 41 from the manual feed tray 12. Provided on the left side of the drying unit 19 is a second conveying path 42 leading from the drying unit 19 to the discharge port 14. Provided above the head units 15 are a third conveying path 43 that is branched from the second conveying path 42 and leads to the discharge tray 13 and a fourth conveying path 44 that is branched from the third conveying path 43 and joins the first conveying path. It is noted that at a branching point between the second conveying path 42 and the third conveying path 43 and a branching point between the third conveying path 43 and the fourth conveying path 44, guide members (not shown) for guiding the conveyance of the sheet Sh1 are provided.

Next, a general outline of an image forming operation of the printer 1 will be described. When an image forming job is input to the printer 1, the sheet Sh1 is fed from the sheet feed cassette 11 or the manual feed tray 12 to be conveyed in a first direction D1 along the first conveying path 41. The sheet Sh1 is conveyed while sticking to the conveying belt 18 of the conveying unit 17. After that, ink droplets are ejected from the head units 15 onto the sheet Sh1, to thus form an image on the surface of the sheet Sh1. On the sheet Sh1 having the image formed on the front surface thereof, drying of the ink is facilitated by the drying unit 19. Then, the sheet Sh1 is conveyed along the second conveying path 42 and the third conveying path 43 and is discharged onto the discharge tray 13.

It is noted that when images are formed on both surfaces of the sheet Sh1, the sheet Sh1 is conveyed in a second direction D2 from the third conveying path 43 to the fourth conveying path 44, and is flipped over from the front surface to the back surface in the middle of the fourth conveying path 44. The sheet Sh1 is then conveyed in a third direction D3 along the fourth conveying path 44 so as to be conveyed again by the conveying belt 18 of the conveying unit 17 while sticking to the conveying belt 18. After that, the ink droplets are ejected from the head units 15 onto the sheet Sh1 so that an image is formed on the back surface of the sheet Sh1. On the sheet Sh1 having the image formed on the back surface thereof, drying of the ink is facilitated by the drying unit 19. Then, the sheet Sh1 is conveyed along the second conveying path 42 and the third conveying path 43 and is discharged onto the discharge tray 13.

Next, an ink supply path in the printer 1 will be described with reference to FIG. 2. It is noted that although FIG. 2 shows a configuration corresponding to one color of ink, the printer 1 uses four colors of ink in the present embodiment, so the printer 1 is actually further provided with configurations respectively corresponding to the remaining three colors of ink.

The printer 1 includes a container attachment portion 31 to which an ink container 3 that stores ink is attached, a pump 32 that sucks the ink from the ink container 3, a filter 33 that filters the ink sucked by the pump 32, and a sub-tank 34 that accumulates the ink delivered from the pump 32. The printer 1 also includes a pump (not shown) that delivers the ink accumulated in the sub-tank 34 to the head unit 15. The ink container 3, the filter 33, the pump 32, and the sub-tank 34 are connected to one another by a main pipe 35. Further, a lower end portion of the main pipe 35 is connected to one of a first relay pipe 36 and a second relay pipe 37. When the ink supply device 2 is not used, the lower end portion of the main pipe 35 is connected to the ink container 3 via the first relay pipe 36. When the ink supply device 2 is used, the lower end portion of the main pipe 35 is connected to a coupling 38 provided at a back portion of the housing 10 via the second relay pipe 37.

### 2 Configuration of ink supply device

Next, the ink supply device 2 will be described with reference to FIG. 2. It is noted that although FIG. 2 shows a configuration corresponding to one color of ink, four colors of ink is used in the present embodiment, so the ink supply device 2 is actually further provided with configurations respectively corresponding to the remaining three colors of ink.

The ink supply device 2 includes a container attachment portion 22 to which an ink container 21 that stores ink is attached, a spare container attachment portion 23 to which a spare ink container 21 is attached, and a heater unit 5 that heats the ink delivered from the ink container 21. It is noted that although the ink supply device 2 includes the spare container attachment portion 23 in the present embodiment, the spare container attachment portion 23 does not need to be provided. Further, although not shown in FIG. 2, the ink supply device 2 further includes a heater control device 6 that controls the heater unit 5. The heater control device 6 will be described in detail in "[3] Configuration of heater control device".

The ink container 21 has a larger volume than the ink container 3 attached inside the printer 1. In the present embodiment, the printer 1 uses four colors of ink, so the ink supply device 2 is provided with four ink containers 21 that respectively store the ink of the four colors of yellow, black, cyan, and magenta. The same holds true for the spare ink container 21.

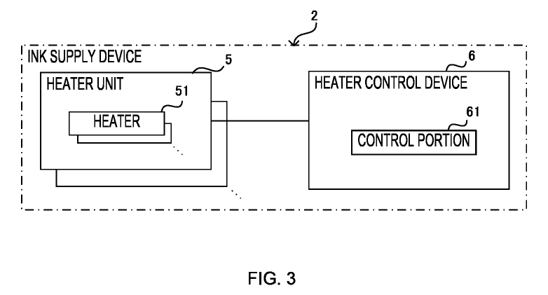

The heater unit 5 includes a metal plate (not shown), a pipe 52, and a heater 51 (see FIG. 3). In the present embodiment, two metal plates opposing each other are provided inside a housing (not shown) that forms an outer shell of the heater unit 5. The metal plates are, for example, plates formed of an aluminum alloy, a copper alloy, or the like.

The pipe 52 is provided between the two metal plates and is in contact with each of the metal plates. The pipe 52 is formed of, for example, stainless steel or the like. The pipe 52 includes a plurality of straight portions 53 each formed in a straight line and curved portions 54 bent into a U-shape for connecting the plurality of straight portions 53 in series. The plurality of straight portions 53 are provided parallel to one another and at equal intervals, so that the pipe 52 is formed in a meandering shape as a whole.

A lower left end portion of the pipe 52 is connected to the ink container 21 via a relay pipe 55, and serves as an inlet for the ink delivered from the ink container 21. An upper left end portion of the pipe 52 is connected to the coupling 38 of the printer 1 via a relay pipe 56, and serves as an outlet for the ink delivered from the ink container 21 via the pipe 52. In other words, the pipe 52 corresponds to an ink supply path that supplies the ink from the ink container 21 to the recording head 16.

The heater 51 is formed in a linear shape and heats the ink supplied from the ink container 21 storing the ink to the recording head 16. The heater 51 is, for example, a cord heater in which an electrically-heated wire is coated with a silicone resin. A plurality of heaters 51 are provided along the pipe 52 with the metal plates in between. Specifically, the plurality of heaters 51 are provided with one of the two metal plates in between, and these plurality of heaters 51 are in contact with the metal plate. Similarly, the plurality of heaters 51 are provided with the other one of the metal plates in between, and these plurality of heaters 51 are in contact with the metal plate. Each of the heaters 51 is connected in parallel to a power supply (not shown) via a power feed line (not shown), and generates heat by receiving supply of power from the power supply.

### 3 Configuration of heater control device

Incidentally, in the printer (inkjet recording apparatus), if the ink cools below a predetermined temperature, a viscosity of the ink decreases, thus making it difficult to supply the ink stably. For this reason, a system that uses a heater to heat the ink (heater control device) is sometimes introduced in the ink supply path from the ink container to the recording head.

In such a system that heats the ink, when the heater 51 is switched from a non-operation state to an operation state by switching the printer from a sleep state or a power-off state to an on state, or the like, that is, when activating the printer, if the ink is cooled before the activation, it takes time to heat the ink, and thus a time required to become printable (start-up time) may become long. Herein, the "non-operation state" refers to a state where the heater 51 is not heating a target or a state where the heater 51 is not energized. Also, the "operation state" refers to a state where the heater 51 is heating a target or a state where the heater 51 is energized.

Herein, an inkjet printer that heats ink to a predetermined temperature is known as the related art. In this inkjet printer, when a measurement value of an ink temperature is equal to or larger than a first reference temperature and smaller than a second reference temperature, a coverage rate of a page to be printed is calculated, and a power supply amount to a heater is changed in accordance with the calculated coverage rate.

As the related art, an inkjet recording apparatus is also known, which performs temperature control in which, in a temperature adjustment portion provided in the mid-course of an ink supply path, the ink temperature at the time of activation and a predetermined threshold temperature are compared, and an ink circulation amount is varied according to the comparison result to advance a recording start time.

However, when the related arts described above are adopted in the control for heating the ink at the time of activation, there arises a problem that, since it is necessary to perform control of elements other than the heater, including the calculation of the coverage rate of a page to be printed, varying of the ink circulation amount, and the like, the control for heating the ink at the time of activation becomes complicated, and a processing load tends to increase.

In contrast, in the present embodiment, by the heater control device 6 to be described below, it becomes possible to realize the heater control device 6 and a heater control method with which the processing load in the control for heating the ink at the time of activation is reduced with ease while shortening the start-up time.

Hereinafter, the heater control device 6 will be described with reference to FIG. 3. The heater control device 6 controls each heater 51 provided in each heater unit 5. The heater control device 6 has, as a main configuration, a computer system including one or more processors and one or more non-volatile memories. Further, the functions of the heater control device 6 are realized by the one or more processors executing a program. The program may be recorded in advance in a memory (storage portion), may be provided through a telecommunication line such as the Internet, or may be provided by being recorded onto a non-transitory recording medium readable by a computer system, such as a memory card or an optical disk. The one or more processors are constituted of one or more electronic circuits including a semiconductor integrated circuit. Furthermore, the computer system used herein includes a microcontroller including one or more processors and one or more memories.

The heater control device 6 includes a control portion 61. Specifically, the one or more processors of the heater control device 6 execute the program stored in the memory. Thus, the heater control device 6 functions as the control portion 61.

When the heater 51 is in the operation state, the control portion 61 controls the heater 51 at a first output. Specifically, when the heater control device 6 and the printer 1 are in the power-on state, that is, when the heater control device 6 and the printer 1 are operating normally, the control portion 61 controls each heater 51 of each heater unit 5 at the first output. Herein, the first output is, for example, a magnitude of power to be supplied to the heater 51 for heating the ink so as to maintain the temperature of the ink delivered from the ink container 21 within a predetermined range. The predetermined range is, for example, a temperature range in which the viscosity of the ink becomes adequate.

In the present embodiment, the control portion 61 performs PWM (Pulse Width Modulation) control on the voltage to be applied to the heater 51 to thus control the heater 51 at the first output. It is noted that, without being limited to the PWM control, the control portion 61 may, for example, increase or decrease a voltage to be applied to the heater 51 or a current to be caused to flow in each heater 51, to thus control the heater 51 at the first output.

Furthermore, the control portion 61 executes output augmentation control for controlling, when the heater 51 is switched from the non-operation state to the operation state, that is, when the heater control device 6 and the printer 1 are activated, the heater 51 at a second output larger than the first output until a predetermined time elapses since the switch. In other words, the control portion 61 executes an operation of controlling the heater 51 at an output (second output) larger than an output during a normal time (first output) until a predetermined time elapses since the activation of the heater control device 6 and the printer 1.

In the present embodiment, the control portion 61 performs the PWM control on the voltage to be applied to the heater 51, to control the heater 51 at the second output. It is noted that, without being limited to the PWM control, the control portion 61 may, for example, increase or decrease the voltage to be applied to the heater 51 or the current to be caused to flow in the heater 51, to thus control the heater 51 at the second output.

It is noted that in the present embodiment, the predetermined time is stored in advance in the memory of the heater control device 6. That is, in the present embodiment, instead of calculating the predetermined time when the heater control device 6 is activated, the heater control device 6 references the predetermined time stored in advance in the memory.

In the present embodiment, for example, when an agglomeration temperature of the ink is represented by "T1", the temperature of the heater 51 in the case where the heater 51 is controlled at the first output is represented by "T2", and the temperature of the heater 51 in the case where the heater 51 is controlled at the second output is represented by "T3", the second output is set so that T1 > T3 > T2 is established. Herein, the agglomeration temperature is a temperature at which agglomeration starts when the ink is heated continuously, and is a unique value set for each ink type. More specifically, the agglomeration temperature is a temperature at which agglomeration starts when the ink is heated continuously, and coarse particles having a diameter of several hundred nm or more start to be generated, for example.

In the present embodiment, the predetermined time is determined based on the agglomeration temperature described above and a rate of a temperature rise when the ink is heated at the second output. The rate of a temperature rise corresponds to an amount of increase in temperature of the ink per unit time. For example, when the second output is large, that is, when the rate of a temperature rise is large, the predetermined time is determined to become short. Further, for example, when the second output is small, that is, when the rate of a temperature rise is small, the predetermined time is determined to become long.

By setting the predetermined time in this manner, it becomes easy to avoid a situation where the ink agglomerates due to the heater 51 continuously being controlled at the second output.

Also in the present embodiment, the predetermined time is determined further based on a temperature of an environment where the heater control device 6 is installed (hereinafter, will be referred to as "environmental temperature"). Herein, the environmental temperature is, for example, a temperature of a room where the heater control device 6 is installed, an ambient temperature at a location where the heater control device 6 is installed, an internal temperature of the heater control device 6, or the like. Herein, when the environmental temperature, that is, the temperature of a room where the heater control device 6 is installed, is represented by "Tc", the rate of a temperature rise is represented by "V1", and the predetermined time is represented by "P1", the predetermined time is determined so as to satisfy T1 ≥ Tc + V1 x P1.

In the present embodiment, the heater control device 6 does not include a temperature sensor for measuring the environmental temperature and also does not have a function of acquiring the environmental temperature from an external temperature sensor. Therefore, in the present embodiment, the environmental temperature is set to a maximum value of a temperature that may be reached in the environment where the heater control device 6 is installed, that has been measured in advance. Herein, the environmental temperature may be set for each season, for example. For example, when the heater control device 6 has a function of counting a current date and time, the environmental temperature corresponding to the current date and time may be read from the memory and used.

By determining the predetermined time in this manner, it becomes easier to avoid agglomeration of the ink due to the heater 51 being continuously controlled at the second output than in a case where the environmental temperature is not taken into consideration.

### 4 Operation of heater control device

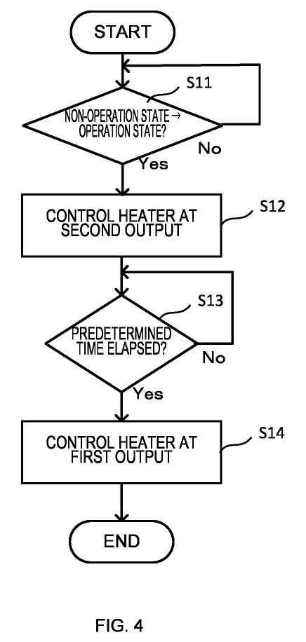

Hereinafter, with reference to FIG. 4, an example of the heater control method according to the present embodiment will be described along with exemplary procedures of determination processing executed by the heater control device 6. Herein, Step S11, Step S12, ... represent numbers of processing procedures (steps) executed by the heater control device 6.

### Step S11

The control portion 61 of the heater control device 6 does not operate while the heater 51 is in the non-operation state (Step S11: No). Then, when the heater 51 is switched from the non-operation state to the operation state (Step S11: Yes), the control portion 61 executes Step S12.

### Step S12

When the heater control device 6 is switched from the non-operation state to the operation state, the control portion 61 of the heater control device 6 executes the output augmentation control for controlling the heater 51 at the second output. Herein, the control portion 61 counts the elapsed time from the start of the output augmentation control (that is, the time of switch).

### Step S13

The control portion 61 of the heater control device 6 continues the output augmentation control until the counted elapsed time reaches a predetermined time, that is, until the predetermined time elapses since the start of the output augmentation control (Step S13: No). Then, when the counted elapsed time has reached the predetermined time, that is, when the predetermined time has elapsed since the start of the output augmentation control (Step S13: Yes), the control portion 61 executes Step S14.

### Step S14

The control portion 61 of the heater control device 6 stops the output augmentation control. Then, the control portion 61 controls the heater 51 at the first output. After that, the control portion 61 continues the control described above until the heater 51 is switched from the operation state to the non-operation state.

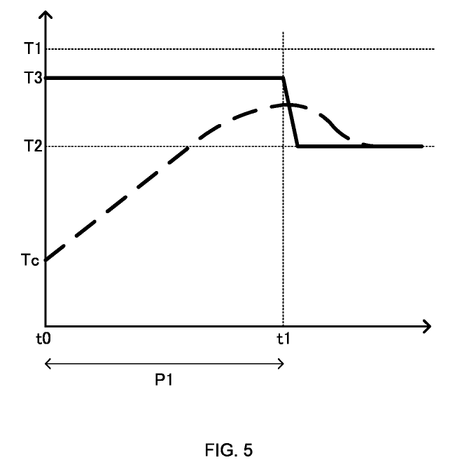

Hereinafter, a specific example of the operation of the heater control device 6 will be described with reference to FIG. 5. In FIG. 5, the vertical axis represents the temperature, and the horizontal axis represents the elapsed time since the activation of the heater control device 6. Also in FIG. 5, the solid line indicates the temperature of the heater 51, and the broken line indicates the temperature of the ink. Further, in the example shown in FIG. 5, it is assumed that the non-operation state of the heater 51 has continued for a sufficiently long period of time before activation, and that the temperature of the ink has cooled down to approximately the ambient temperature.

As shown in FIG. 5, the control portion 61 of the heater control device 6 executes the output augmentation control for controlling the heater 51 at the second output from a time t0 (that is, at the time of activation of the heater control device 6). Thus, the temperature of the heater becomes "T3", and the ink is heated by the heater 51. Then, the temperature of the ink rises over time from "Tc", which is the environmental temperature.

After that, the control portion 61 stops the output augmentation control at a time t1 (that is, a time point when a predetermined time "P1" has elapsed since the activation of the heater control device 6). Thus, a situation where the temperature of the ink rises to the agglomeration temperature "T1" is avoided.

After the time t1, the control portion 61 controls the heater 51 at the first output. Thus, the temperature of the heater 51 becomes "T2", and the temperature of the ink also converges to "T2", which is the temperature of the heater 51, over time.

As described above, in the heater control device 6 according to the present embodiment, the output augmentation control for controlling the heater 51 at the second output when the heater 51 is switched from the non-operation state to the operation state, that is, when the heater control device 6 is activated, is executed. Therefore, in the heater control device 6 according to the present embodiment, the output of the heater 51 is temporarily increased to heat the ink at the time of the activation of the heater control device 6, so it is possible to shorten the start-up time as compared to a case where the output of the heater 51 is not increased.

Furthermore, in the heater control device 6 according to the present embodiment, the control for heating the ink at the time of activation is control in which the output augmentation control is executed only for the predetermined time starting from the time of switch, so there is no need to control elements other than the heater 51 as in the related arts already described above, and thus it becomes easy to reduce the processing load in the control for heating the ink at the time of activation.

### 5 Modified examples

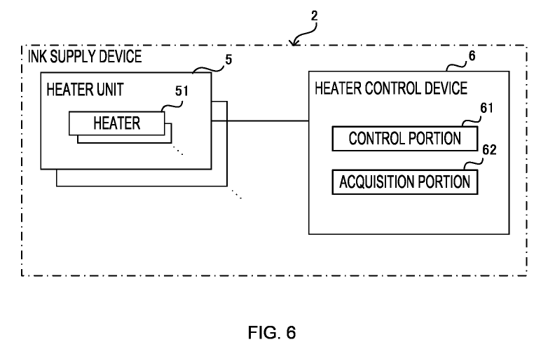

The heater control device 6 according to the present embodiment does not have the function of acquiring the environmental temperature, but the heater control device 6 may alternatively be provided with the function of acquiring the environmental temperature. Specifically, the heater control device 6 may further include an acquisition portion 62 as shown in FIG. 6.

The acquisition portion 62 acquires the environmental temperature when the heater 51 is switched from the non-operation state to the operation state. For example, the acquisition portion 62 acquires the environmental temperature by communicating with a sensor that measures the environmental temperature and receiving a detection result of the sensor. It is noted that the acquisition portion 62 may alternatively communicate with the printer 1 to acquire the environmental temperature input by a user via a user interface provided in the printer 1, for example.

In the configuration described above, the heater control device 6 may calculate the predetermined time according to the environmental temperature acquired by the acquisition portion 62. For example, when the environmental temperature acquired by the acquisition portion 62 is deviated from a range including a default value of the environmental temperature, the heater control device 6 may recalculate the predetermined time according to the environmental temperature acquired by the acquisition portion 62. Specifically, when the environmental temperature acquired by the acquisition portion 62 exceeds the range described above, the heater control device 6 may recalculate the predetermined time so as to shorten the predetermined time. On the other hand, when the environmental temperature acquired by the acquisition portion 62 falls below the range described above, the heater control device 6 may recalculate the predetermined time so as to prolong the predetermined time. It is noted that when the environmental temperature acquired by the acquisition portion 62 is within the range described above, the heater control device 6 does not need to recalculate the predetermined time.

In the present embodiment, the control portion 61 of the heater control device 6 may determine whether or not to execute the output augmentation control based on a duration time of the non-operation state of the heater 51. The duration time can be calculated from, for example, a difference between a time when the heater 51 is switched from the operation state to the non-operation state and a time when the heater 51 is switched from the non-operation state to the operation state. For example, the control portion 61 may determine to execute the output augmentation control when the duration time is equal to or longer than a preset threshold time, and may determine not to execute the output augmentation control when the duration time is shorter than the threshold time.

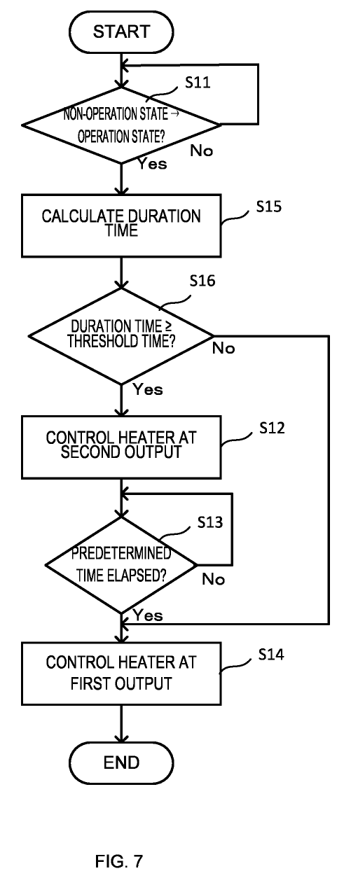

FIG. 7 is a flowchart showing an operation example in the configuration described above. It is noted that since Steps S11 to S14 have already been described above, descriptions thereof will be omitted herein.

### Step S15

Step S15 is executed when the heater 51 is switched from the non-operation state to the operation state (Step S11: Yes). In Step S15, the heater control device 6 calculates the duration time.

### Step S16

When the calculated duration time is equal to or larger than the threshold time (Step S16: Yes), the heater control device 6 executes Step S12, that is, executes the output augmentation control. On the other hand, when the calculated duration time is shorter than the threshold time (Step S16: No), the heater control device 6 executes Step S14 without executing Step S12, that is, does not execute the output augmentation control.

According to this configuration, since the output augmentation control is not executed when the duration time is shorter than the threshold time, that is, when it is assumed that the ink is hardly cooled, it becomes easier to reduce the processing load in the control for heating the ink at the time of activation.

In the present embodiment, the heater 51 is a cord heater, but the present disclosure is not limited to this. Further, although the heater 51 indirectly heats the ink that passes through the pipe 52 via the metal plates, it is also possible for the heater 51 to directly heat the ink that passes through the pipe 52 without the intervention of the metal plates. Alternatively, the heater 51 may heat the ink in a non-contact manner without coming into contact with the pipe 52, for example. It is noted that when the configuration of the heater 51 is changed from that of the present embodiment, the temperatures "T1", "T2", and "T3" described above only need to be changed according to the configuration of the heater 51.

In the present embodiment, the heater control device 6 is provided in the ink supply device 2, but the present disclosure is not limited to this. For example, the heater control device 6 may be provided in the printer 1. In this case, the heater control device 6 may be configured to heat the ink by controlling the heater 51 provided on an ink supply path (for example, main pipe 35 or the like) from the ink container 3 provided in the printer 1 to the recording head 16.

Furthermore, the image forming target on which an image is to be formed by the printer 1 is not limited to the sheet Sh1 such as paper or a resin film, and may be, for example, a roll of fabric such as nonwoven fabric or cloth. In this case, the printer 1 is a textile printing machine (textile printer) that records an image on the fabric by ejecting ink onto the fabric and dyeing fibers of the fabric with the ink.

### Notes of disclosure

Hereinafter, a general outline of the disclosure extracted from the embodiment described above will be noted. It is noted that the respective configurations and processing functions described in the notes below can be sorted and arbitrarily combined as appropriate.

### Note 1

A heater control device which controls a heater that heats ink supplied from an ink container storing the ink to a recording head, including:

a control portion which controls, when the heater is in an operation state, the heater at a first output, and executes, when the heater is switched from a non-operation state to the operation state, output augmentation control for controlling the heater at a second output larger than the first output until a predetermined time elapses since the switch.

### Note 2

The heater control device according to note 1, in which

the predetermined time is determined based on an agglomeration temperature at which agglomeration of the ink starts by being heated continuously and a rate of a temperature rise when heating the ink at the second output.

### Note 3

The heater control device according to note 2, in which

the predetermined time is determined further based on a temperature of an environment where the heater control device is installed.

### Note 4

The heater control device according to any one of notes 1 to 3, in which

the control portion determines whether or not to execute the output augmentation control based on a duration time of the non-operation state.

### Note 5

An ink supply device, including:

the heater control device according to any one of notes 1 to 4;

the heater;

the ink container; and

an ink supply path for supplying the ink from the ink container to the recording head.

### Note 6

An image forming system, including:

the ink supply device according to note 5; and

an inkjet recording apparatus which ejects the ink supplied from the ink container from the recording head to form an image.

### Note 7

A heater control method for controlling a heater that heats ink supplied from an ink container storing the ink to a recording head, including:

a control step of controlling, when the heater is in an operation state, the heater at a first output, and executing, when the heater is switched from a non-operation state to the operation state, output augmentation control for controlling the heater at a second output larger than the first output until a predetermined time elapses since the switch.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. A heater control device which controls a heater that heats ink supplied from an ink container storing the ink to a recording head, comprising:
a control portion which controls, when the heater is in an operation state, the heater at a first output, and executes, when the heater is switched from a non-operation state to the operation state, output augmentation control for controlling the heater at a second output larger than the first output until a predetermined time elapses since the switch.

2. The heater control device according to claim 1, wherein
the predetermined time is determined based on an agglomeration temperature at which agglomeration of the ink starts by being heated continuously and a rate of a temperature rise when heating the ink at the second output.

3. The heater control device according to claim 2, wherein
the predetermined time is determined further based on a temperature of an environment where the heater control device is installed.

4. The heater control device according to claim 1, wherein
the control portion determines whether or not to execute the output augmentation control based on a duration time of the non-operation state.

5. An ink supply device, comprising:
the heater control device according to claim 1;
the heater;
the ink container; and
an ink supply path for supplying the ink from the ink container to the recording head.

6. An image forming system, comprising:
the ink supply device according to claim 5; and
an inkjet recording apparatus which ejects the ink supplied from the ink container from the recording head to form an image.

7. A heater control method for controlling a heater that heats ink supplied from an ink container storing the ink to a recording head, comprising:
a control step of controlling, when the heater is in an operation state, the heater at a first output, and executing, when the heater is switched from a non-operation state to the operation state, output augmentation control for controlling the heater at a second output larger than the first output until a predetermined time elapses since the switch.
